(19) United States
(12) Patent Application Publication
(10) Pub. No.: US 2017/0144907 A1
(43) Pub. Date: May 25, 2017

(54) APPARATUS FOR PHOTO OXIDATION REACTION

(71) Applicant: S&P Environmental Technology Co., Ltd., Buk-gu (KR)

(72) Inventor: Jong-Seob Shim, Buk-Gu (KR)

(21) Appl. No.: 15/348,526

(22) Filed: Nov. 10, 2016

(30) Foreign Application Priority Data
Nov. 24, 2015 (KR) 10-2015-0164939

(51) Int. Cl. C02F 1/72; C02F 1/32; C02F 1/66

(52) U.S. Cl. CPC C02F 1/722; C02F 1/66; C02F 1/325; C02F 2201/3223; C02F 2209/02; C02F 2209/06

(57) ABSTRACT

An apparatus for photo oxidation reaction in accordance with an aspect of the present invention includes: a reactor including a housing having a hollow space extended therein in a lengthwise direction and having openings formed at either end thereof in the lengthwise direction so as to open the hollow space to an outside, an inlet header having an inlet formed thereon for communication with the hollow space, and an outlet header having an outlet formed thereon for communication with the hollow space; a quartz tube formed to be extended along the lengthwise direction of the housing and installed in the reactor so as to be arranged inside the housing; an ultraviolet lamp inserted in the quartz tube; and a hydrogen peroxide supply unit installed so as to disperse and supply hydrogen peroxide to the hollow space at a plurality of locations separated in the lengthwise direction of the housing.

### CROSS-REFERENCE TO RELATED APPLICATIONS

This application claims the benefit of Korean Patent Application No. 10-2015-0164939, filed with the Korean Intellectual Property Office on Nov. 24, 2015, the disclosure of which is incorporated herein by reference in its entirety.

### BACKGROUND

1. Technical Field

The present invention relates to an apparatus for photo oxidation reaction.

2. Background Art

Water treatment refers to removing or colleting harmful substances contained in wastewater and treating the wastewater to have a predetermined allowable water quality. The methods of water treatment largely include physical methods such as, for example, ordinary precipitation, coagulative precipitation, floatation and filtration, chemical methods such as, for example, oxidation, reduction, neutralization and ion exchange, and biological methods such as, for example, activated sludge method, trickling filter method and digestion method, using microorganisms.

Among the above methods, the advanced oxidation process oxidizes and decomposes contaminants contained in the wastewater by generating OH-radicals having a strong oxidizing power, and can treat non-biodegradable substances, such as synthetic detergents and pesticides, which are not easily decomposed by the biological methods, in a short time.

Some examples of the advanced oxidation process include generating the OH-radicals using ozone and generating the OH-radicals using hydrogen peroxide. The advanced oxidation process using ozone has several shortcomings, such as the difficult process control, the requirement for a large facility and the requirement for an additional facility for decomposing ozone waste.

The advanced oxidation process using hydrogen peroxide and ultraviolet rays to generate the OH-radicals can be implemented with a simple equipment configuration and with a simple process control and thus can be automated. However, hydrogen peroxide inputted for the generation of OH-radicals reacts with the OH-radicals to result in a side reaction of consuming the OH-radicals, possibly deteriorating the efficiency of the equipment.

The related art is described in Korean Patent 10-1545878 (published on Aug. 20, 2015).

### SUMMARY

Embodiments of the present invention provide an apparatus for photo oxidation reaction that can improve the efficiency of water treatment.

According to an aspect of the present invention, an apparatus for photo oxidation reaction includes: a reactor including a housing having a hollow space extended therein in a lengthwise direction and having openings formed at either end thereof in the lengthwise direction so as to open the hollow space to an outside, an inlet header having an inlet formed thereon for communication with the hollow space in order to allow wastewater to be flowed into the hollow space and being coupled to one end of the housing so as to cover the opening formed at the one end of the housing, and an outlet header having an outlet formed thereon for communication with the hollow space in order to allow the wastewater having passed through the hollow space to be flowed out to an outside and being coupled to the other end of the housing so as to cover the opening formed at the other end of the housing; a quartz tube formed to be extended along the lengthwise direction of the housing and installed in the reactor so as to be arranged inside the housing; an ultraviolet lamp inserted in the quartz tube so as to emit ultraviolet rays to the hollow space; and a hydrogen peroxide supply unit installed on the so as to disperse and supply hydrogen peroxide to the hollow space at a plurality of locations separated in the lengthwise direction of the housing.

Here, the housing may be installed in plurality, and the inlet header may be coupled to one ends of the plurality of housings so as to integrally cover openings formed, respectively, at the one ends of the plurality of housings, and the outlet header may be coupled to the other ends of the plurality of housings so as to integrally cover openings formed, respectively, at the other ends of the plurality of housings.

The hydrogen peroxide supply unit may include a plurality of hydrogen peroxide inlets communicated with the hollow space and separated from one another in the lengthwise direction of the housing.

The hydrogen peroxide supply unit may include the inlet formed on the inlet header.

The hydrogen peroxide supply unit may include a hydrogen peroxide supply tube installed in the hollow space and having a plurality of through-holes formed therein such that hydrogen peroxide flowed into the reactor through one open end of the hydrogen peroxide supply unit that is arranged to be exposed to the outside of the reactor is dispersed and supplied to the hollow space.

The hydrogen peroxide supply tube may be formed in a spiral shape arranged to surround an outer circumferential surface of the quartz tube.

The hydrogen peroxide supply tube may be formed in an annular shape arranged to surround an outer circumferential surface of the quartz tube at least once.

The housing may be divided into a first partition housing and a second partition housing having the inlet header and the outlet header coupled thereto, respectively, at one end thereof in the lengthwise direction of the housing, and the first partition housing may include a supplementary outlet formed at the other end thereof so as to be communicated with a hollow space formed therein, and the second partition housing may include a supplementary inlet formed at the other end thereof so as to be communicated with a hollow space formed therein, and the first partition housing and the second partition housing may be connected with each other such that the respective hollow spaces are separated from each other, and the hydrogen peroxide supply unit may include the inlet of the inlet header and the supplementary inlet of the second partition housing.

The reactor may be installed in plurality, and the plurality of reactors may be arranged such that wastewater is flowed in through an inlet of each of the plurality of reactors.

The apparatus may further include an additional reactor installed to re-treat the wastewater flowed out from the outlet of the reactor, and the additional reactor may be arranged in such a way that the wastewater flowed out from the outlet of the reactor is flowed into the additional reactor through an inlet of the additional reactor.

The reactor and/or the additional reactor may be installed in plurality.

The apparatus may further include a temperature controller and pH controller installed between the outlet of the reactor and the inlet of the additional reactor such that the wastewater is supplied to the inlet of the additional reactor by adjusting the temperature and pH of the wastewater discharged from the outlet of the reactor.

According to certain embodiments of the present invention, it is possible to provide an apparatus for photo oxidation reaction that can improve the efficiency of water treatment because the apparatus includes the hydrogen peroxide supply unit that disperses and supplies hydrogen peroxide by uniformly distributing the concentration of hydrogen peroxide in the lengthwise direction of the housing such that a consumption reaction of OH-radicals by hydrogen peroxide is restricted.

### BRIEF DESCRIPTION OF DRAWINGS

FIG. 1 illustrates a photo oxidation reaction apparatus in accordance with a first embodiment of the present invention.

FIG. 2 illustrates an inside of the photo oxidation reaction apparatus shown in FIG. 1.

FIG. 3 illustrates a reactor of the photo oxidation reaction apparatus shown in FIG. 1.

FIG. 4 illustrates an example of modification of a hydrogen peroxide supply unit in the photo oxidation reaction apparatus shown in FIG. 1.

FIG. 5 is another example of modification of the hydrogen peroxide supply unit in the photo oxidation reaction apparatus shown in FIG. 1.

FIG. 6 is an example of modification of a housing in the photo oxidation reaction apparatus shown in FIG. 1.

FIG. 7 illustrates an inside of the photo oxidation reaction apparatus shown in FIG. 6.

FIG. 8 illustrates a photo oxidation reaction apparatus in accordance with a second embodiment of the present invention.

FIG. 9 illustrates a photo oxidation reaction apparatus in accordance with a third embodiment of the present invention.

FIG. 10 illustrates a photo oxidation reaction apparatus in accordance with a fourth embodiment of the present invention.

FIG. 11 illustrates a photo oxidation reaction apparatus in accordance with a fifth embodiment of the present invention.

FIG. 12 illustrates a photo oxidation reaction apparatus in accordance with a sixth embodiment of the present invention.

### DETAILED DESCRIPTION

The terms used in the description are intended to describe certain embodiments only, and shall by no means restrict the present invention. Unless clearly used otherwise, expressions in a singular form include a meaning of a plural form.

In the present description, an expression such as “comprising” or “including” is intended to designate a characteristic, a number, a step, an operation, an element, a part or combinations thereof, and shall not be construed to preclude any presence or possibility of one or more other characteristics, numbers, steps, operations, elements, parts or combinations thereof. Moreover, throughout the description, when an element is described to be “on” an object, it shall mean that the element is positioned above or below the target and shall not necessarily mean that the element is positioned at an upper side of the object in a gravitational direction.

When one element is described to be “coupled” to another element, it does not refer to a physical, direct contact between these elements only, but it shall also include the possibility of yet another element being interposed between these elements and each of these elements being in contact with said yet another element.

Terms such as “first” and “second” can be used in merely distinguishing one element from other identical or corresponding elements, but the above elements shall not be restricted to the above terms.

The size and thickness of each element illustrated in the drawings are provided for the convenience of description and illustration, and the present invention shall not be restricted to the illustrated size and thickness.

Hereinafter, certain embodiments of a photo oxidation reaction apparatus in accordance with the present invention will be described in detail with reference to the accompanying drawings. In describing the present invention with reference to the accompanying drawings, any identical or corresponding elements will be assigned with same reference numerals, and no redundant description thereof will be provided.

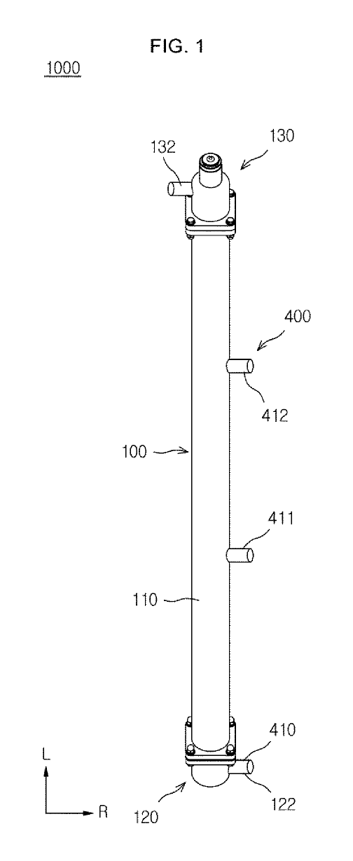

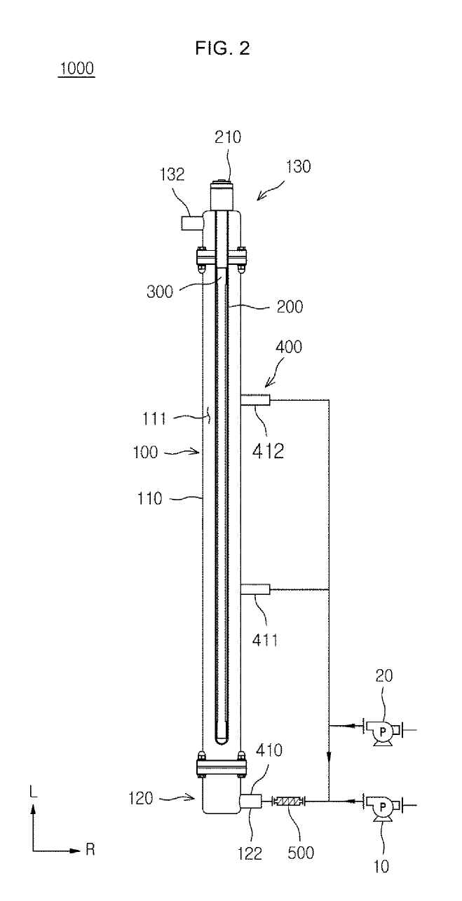

FIG. 1 illustrates a photo oxidation reaction apparatus in accordance with a first embodiment of the present invention, and FIG. 2 illustrates an inside of the photo oxidation reaction apparatus shown in FIG. 1.

Referring to FIG. 1 and FIG. 2, a photo oxidation reaction apparatus 1000 in accordance with a first embodiment of the present invention includes a reactor 100, a quartz tube 200, an ultraviolet lamp 300 and a hydrogen peroxide supply unit 400.

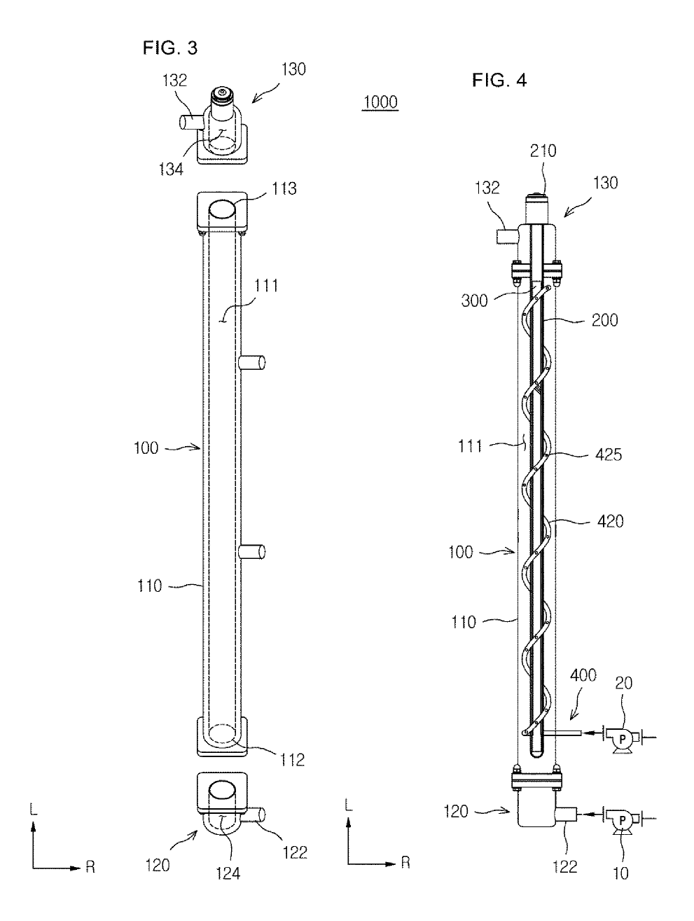

FIG. 3 illustrates a reactor of the photo oxidation reaction apparatus shown in FIG. 1.

Referring to FIG. 3, the reactor 100 of the photo oxidation reaction apparatus 1000 in accordance with the present embodiment is a portion that forms an overall external appearance of the apparatus and includes a housing 110, an inlet header 120 and an outlet header 130.

The housing 110 includes a hollow space 111, which is extended in a lengthwise direction L inside the housing 110, and openings 112, 113, which are formed at either end of the housing 110 in the lengthwise direction L so as to open the hollow space 111 to an outside.

The housing 110 may be formed in the shape of a cylindrical column having the lengthwise direction L and a radial direction R, and the hollow space 111 formed inside the housing 110 may be formed to have a circular cross-sectional shape.

By forming the hollow space 111 with the circular cross-sectional shape, ultraviolet rays emitted radially by the ultraviolet lamp 300 can be uniformly reached to an inner circumferential surface of the hollow space 111, eliminating blind areas in which the ultraviolet rays do not reach. Here, the diameter of the cross-section of the hollow space 111 may be designed according to, for example, an output of the ultraviolet lamp 300 or a wavelength of the ultraviolet rays emitted by the ultraviolet lamp 300.

The inlet header 120 is a portion formed with an inlet 122, which is communicated with the hollow space 111 of the housing 110 so as to allow wastewater to flow into the hollow space 111 formed inside the housing 110, and is coupled with one end of the housing 110 so as to cover the opening 112 formed at the one end of the housing 110. Here, a coupling surface of the inlet header 120 being coupled with the one end of the housing 110 may be formed with an opening portion corresponding to the opening 112 of the housing 110.

The outlet header 130 is a portion formed with an outlet 132, which is communicated with the hollow space 111 of the housing 110 so as to allow the wastewater having passed through the hollow space 111 formed inside the housing 110 to flow out to an outside, and is coupled with the other end of the housing 110 so as to cover the opening 113 formed at the other end of the housing 110. Here, a coupling surface of the outlet header 130 being coupled with the other end of the housing 110 may be formed with an opening portion corresponding to the opening 113 of the housing 110.

The inlet header 120 may include a first header space 124, which is communicated with both the inlet 122 and the hollow space 111 of the housing 110. Similarly, the outlet header 130 may include a second header space 134, which is communicated with both the outlet 132 and the hollow space 111 of the housing 110.

The inlet 122 of the inlet header 120 and the outlet 132 of the outlet header 130 are each opened at one end thereof and are communicated with the first header space 124 and the second header space 134, respectively, at the other end thereof, and the first header space 124 and the second header space 134 are communicated with the hollow space 111 of the housing 110. Accordingly, the wastewater flowed in from the outside through the inlet 122 may be discharged to the outside again through the outlet 132 after passing through the hollow space 111 along the lengthwise direction L of the housing 110.

Meanwhile, while it is possible that the housing 110, the inlet header 120 and the outlet header 130 included in the reactor 100 may be integrally formed to configure a single body, it is also possible that, as illustrated in FIG. 3, the housing 110, the inlet header 120 and the outlet header 130 are each formed as an independent body and welded with each other or mechanically fastened using, for example, bolts and nuts.

Referring to FIG. 1 and FIG. 2 again, the quartz tube 200 is extended along the lengthwise direction L of the housing 110 and is installed in the reactor 100 in such a way that the quartz tube 200 is arranged inside the housing 110. The quartz tube 200 may be formed to be substantially identical with the length of the hollow space 111 or slightly shorter than the hollow space 111 such that the quartz tube 200 is arranged throughout most of the hollow space 111.

The quartz tube 200 is disposed inside the reactor 100, particularly within the hollow space 111, and one end of the quartz tube 200 may be coupled with one end of the reactor 100 in the lengthwise direction L so as to restrict a movement of the quartz tube 200 inside the reactor 100.

For example, the one end of the quartz tube 200 may be coupled to be projected to an outside of the reactor 100 by penetrating the outlet header 130, and a quartz tube fastening unit 210 may be coupled to the outside of the reactor 100 so as to cover the one end of the quartz tube 200 projected to the outside of the reactor 100 and fasten the quartz tube 200 at the same time.

The ultraviolet lamp 300 is inserted into the quartz tube 200 to emit the ultraviolet rays to the hollow space 111. The ultraviolet lamp 300 may be configured with a long stick shape of lamp. A receiving space for accommodating the ultraviolet lamp 300 is provided inside the quartz tube 200, and the ultraviolet lamp 300 may be inserted into the receiving space of the quartz tube 200.

As the quartz tube 200 and the ultraviolet lamp 300 inserted therein are extended in the lengthwise direction L of the housing 110 and installed throughout most of the hollow space 111, it is possible that the ultraviolet rays emitted by the ultraviolet lamp 300 reach an entire region of the hollow space 111 in the lengthwise direction L.

The quartz tube 200 may be formed to seal off the receiving space, in which the ultraviolet lamp 300 is inserted, in order to protect the ultraviolet lamp 300 from the wastewater (and hydrogen peroxide, which will be described later) flowed into the hollow space 111 and may be formed by including a material having a high ultraviolet transmissivity so as to allow the ultraviolet rays emitted by the ultraviolet lamp 300 to be transmitted and to reach the hollow space 111.

The ultraviolet lamp 300 may be a mercury lamp, an amalgam lamp or a xenon lamp, and as described above, the cross-sectional diameter of the hollow space 111 may be determined according to a range of amount of light emitted by the ultraviolet lamp 300.

The hydrogen peroxide supply unit 400 is installed on the reactor 100 such that hydrogen peroxide is dispersed and supplied to the hollow space 111 at a plurality of locations separated in the lengthwise direction L of the housing 100. The hydrogen peroxide supply unit 400 can supply hydrogen peroxide into the reactor 100, that is, to the hollow space 111 and/or the first header space 124 (see FIG. 3), by dispersing hydrogen peroxide at locations different from one another.

The photo oxidation reaction apparatus 1000 in accordance with the present embodiment is a water treatment apparatus for oxidizing and decomposing various contaminants included in the wastewater flowed into the reactor 100, more specifically into the hollow space 111. That is, the wastewater flowed into the hollow space 111 through the inlet 122 of the inlet header 120 is treated while passing through the hollow space 111 in a flow direction parallel to the lengthwise direction L of the housing 100 and is discharged to the outside through the outlet 132 of the outlet header 130.

Specifically, hydrogen peroxide supplied to the hollow space 111 by the hydrogen peroxide supply unit 400 is decomposed by the ultraviolet rays emitted by the ultraviolet lamp 300 disposed inside the housing 110 to generate hydroxyl radicals (OH-radicals) having a strong oxidizing power. The OH-radicals generated by having hydrogen peroxide decomposed react in the hollow space 111 of the housing 110 with the wastewater flowing in the lengthwise direction L of the housing 110, resulting in oxidation and decomposition of the contaminants contained in the wastewater.

Meanwhile, hydrogen peroxide undecomposed by the ultraviolet rays and remaining unreacted within the hollow space 111 may react with the generated OH-radicals to cause a side reaction of consuming the OH-radicals. As a result, some of the OH-radicals generated by the decomposition of hydrogen peroxide cannot participate in oxidation and decomposition of the contaminants, and thus the efficiency of water treatment by the apparatus may be deteriorated.

The above-described phenomenon, i.e., OH-radicals being consumed by the unreacted hydrogen peroxide, may be occurred more frequently when there is a greater difference in concentration of hydrogen peroxide distributed in the hollow space 111 in the lengthwise direction L. In other words, in a case where hydrogen peroxide is supplied through the inlet 122 only, the concentration of hydrogen peroxide is higher in the hollow space 111 near the inlet 122 of the reactor 100, and the concentration of hydrogen peroxide may be lower in the hollow space 111 further away from the inlet 122 of the reactor 100.

Since the photo oxidation reaction apparatus 1000 in accordance with the present embodiment includes the hydrogen peroxide supply unit 400 that disperses and supplies hydrogen peroxide to the hollow space 111 at a plurality of locations separated in the lengthwise direction L of the housing 110, it is possible to uniformly maintain the concentration of hydrogen peroxide distributed in the hollow space 111 in the lengthwise direction L. As a result, the photo oxidation reaction apparatus 1000 in accordance with the present embodiment can improve the efficiency of water treatment, by restricting the reaction of having OH-radicals consumed by the unreacted hydrogen peroxide.

As illustrated in FIG. 1 and FIG. 2, the hydrogen peroxide supply unit 400 may include a plurality of hydrogen peroxide inlets 410, 411, 412 that are communicated with the hollow space 111 formed inside the housing 110 and are separated from one another in the lengthwise direction L of the housing 110.

Although it is illustrated in FIG. 1 and FIG. 2 that three hydrogen peroxide inlets 410, 411, 412 are installed apart from one another on the photo oxidation reaction apparatus 1000, the number, locations and separation distances of the hydrogen peroxide inlets 410, 411, 412 may be appropriately increased or decreased according to an overall length of the reactor 100 or the housing 110, an amount of the wastewater flowed into the hollow space 111, a flow speed of the wastewater or an output of the ultraviolet lamp 300.

Meanwhile, in a case where the hydrogen peroxide supply unit 400 includes the plurality of hydrogen peroxide inlets 410, 411, 412, the plurality of hydrogen peroxide inlets 410, 411, 412 may include the inlet 122 formed at the inlet header 120 of the reactor 100. In other words, the inlet 122 formed at the inlet header 120 may be used as an entrance for allowing the wastewater to flow in as well as a hydrogen peroxide inlet 410 at the same time.

Here, the photo oxidation reaction apparatus 1000 in accordance with the present embodiment may further include a mixer 500, which mixes hydrogen peroxide with the wastewater and discharges the mixed hydrogen peroxide and wastewater to the inlet 122 of the inlet header 120. The mixer 500 may be connected with a wastewater inlet pump 10 and a hydrogen peroxide supply pump 20 to allow the wastewater and hydrogen peroxide to be supplied thereto from the pumps 10, 20 and mixed therein before discharging the mixed wastewater and hydrogen peroxide to the inlet 122.

The photo oxidation reaction apparatus 1000 illustrated in FIG. 1 and FIG. 2 can supply hydrogen peroxide into the reactor 100, i.e., to the hollow space 111 of the housing 110, at a plurality of locations separated in the lengthwise direction L of the housing through the plurality of hydrogen peroxide inlets 410, 411, 412, and a plurality of pipes, each connected with the hydrogen peroxide supply pump 20, may be installed at the plurality hydrogen peroxide inlets 410, 411, 412, respectively.

Since the wastewater and/or hydrogen peroxide is supplied and/or flowed into the hollow space 111 of the housing 110 through the inlet 122 of the inlet header 120 and flows within the hollow space 111 in the lengthwise direction L of the housing 111, and the photo oxidation reaction apparatus 1000 in accordance with the present embodiment disperses and supplies hydrogen peroxide at a plurality of locations, it is possible to oxidize and decompose the contaminants contained in the wastewater while the concentration of hydrogen peroxide is uniformly maintained along the flowing direction of the wastewater.

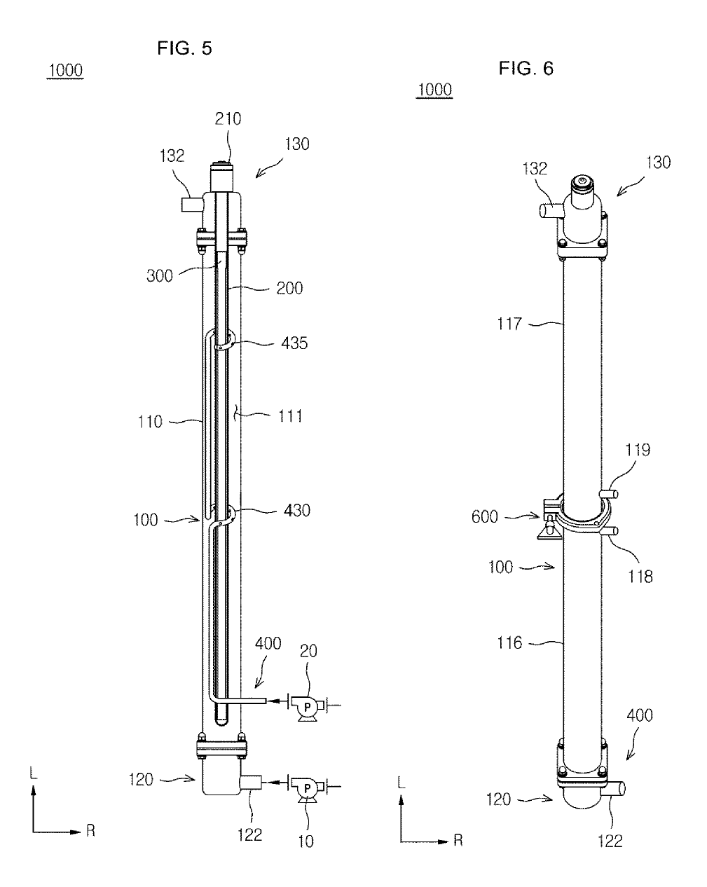

FIG. 4 illustrates an example of modification of the hydrogen peroxide supply unit in the photo oxidation reaction apparatus shown in FIG. 1, and FIG. 5 is another example of modification of the hydrogen peroxide supply unit in the photo oxidation reaction apparatus shown in FIG. 1.

The examples of photo oxidation reaction apparatus 1000 illustrated in FIG. 4 and FIG. 4 include the same or similar elements, except the hydrogen peroxide supply unit 400, as the photo oxidation reaction apparatus 1000 described and illustrated with reference to FIG. 1 to FIG. 3. In other words, the photo oxidation apparatus 1000 shown in each of FIG. 4 and FIG. 5 includes a reactor 100, a quartz tube 200 and an ultraviolet lamp 300, which are similar to the elements of the earlier-described photo oxidation reaction apparatus, and thus the hydrogen peroxide supply unit 400 will be mainly described hereinafter.

Since the hydrogen peroxide supply unit 400 may be installed in the reactor 100 in any of various possible ways as long as hydrogen peroxide can be dispersed and supplied to the hollow space 111 of the housing 110 at a plurality of locations separated in the lengthwise direction L of the housing 110, the specific structure and arrangement of the hydrogen peroxide supply unit 1440 may be variously modified.

Referring to FIG. 4 and FIG. 5, the hydrogen peroxide supply unit 400 may include a hydrogen peroxide supply tube 420, 430, which is installed in the hollow space 111 and has a plurality of through-holes 425, 435 formed therein, such that hydrogen peroxide flowed into the reactor 100 through one open end of the hydrogen peroxide supply unit 400 that is arranged to be exposed to the outside of the reactor 100 can be properly dispersed and supplied to the hollow space 111 of the housing 110.

The hydrogen peroxide supply tube 420, 430 provides a flowing path of hydrogen peroxide flowed in through the one open end thereof that is arranged outside the reactor 100, and includes a plurality of through-holes 425, 435 formed to penetrate the hydrogen peroxide supply tube 420, 430 between an inside and outside of the hydrogen peroxide supply tube 420, 430 along a flowing direction of hydrogen peroxide. Hydrogen peroxide flowing inside the hydrogen peroxide supply tube 420, 430 may be discharged to the hollow space 111 of the housing 110 within the hydrogen peroxide supply tube 420, 430 through the plurality of through-holes 425, 435. Since the plurality of through-holes 425, 435 formed in the hydrogen peroxide supply tube 420, 430 are separated from one another along the flowing direction of hydrogen peroxide, and the hydrogen peroxide supply tube 420, 430 is disposed in the hollow space 111 along the lengthwise direction of the housing 110, it is possible to disperse and supply hydrogen peroxide to the hollow space 111 at a plurality of locations separated in the lengthwise direction of the housing 110.

The hydrogen peroxide supply tube 420, 430 may be formed in various different shapes. For example, as illustrated in FIG. 4, the hydrogen peroxide supply tube 420 may be formed in a spiral shape to surround an outer circumferential surface of the quartz tube 200 disposed inside the housing 110. Alternatively, as illustrated in FIG. 5, the hydrogen peroxide supply tube 430 may be formed in an annular shape to surround the outer circumferential surface of the quartz tube 200 at least once.

The hydrogen peroxide supply tube 430 illustrated in FIG. 5 may include a linear portion, which is elongated along a lengthwise direction of the quartz tube 200, and an annular portion, which is formed to surround a girth of the outer circumferential surface of the quartz tube 200, and the plurality of through-holes 435 may be formed in the annular portion. The linear portion and the annular portion may be each provided in plurality and may be connected with one another.

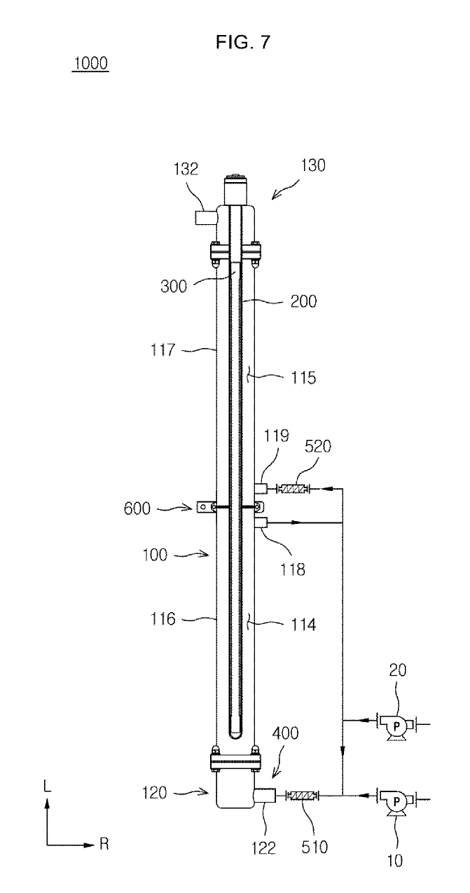

FIG. 6 is an example of modification of a housing in the photo oxidation reaction apparatus shown in FIG. 1, and FIG. 7 illustrates an inside of the photo oxidation reaction apparatus shown in FIG. 6.

A photo oxidation reaction apparatus 1000 illustrated in FIG. 6 and FIG. 7 includes a reactor 100, a quartz tube 200, an ultraviolet lamp 300 and a hydrogen peroxide supply unit 400, similarly to the photo oxidation reaction apparatus described with reference to FIG. 1 and FIG. 2. Nevertheless, since the photo oxidation reaction apparatus 1000 illustrated in FIG. 6 and FIG. 7 shows a modified example of the housing 110 of the photo oxidation reaction apparatus illustrated with reference to FIG. 1 and FIG. 2, this difference will be mainly described below.

The housing of the photo oxidation reaction apparatus 1000 illustrated in FIG. 6 and FIG. 7 is divided into a first partition housing 116 and a second partition housing 117 being coupled with an inlet header 120 and an outlet header 130, respectively, at one end thereof in the lengthwise direction L. The first partition housing 116 and the second partition housing 117 have hollow spaces 114, 115 separably coupled thereto, respectively, and have a supplementary outlet 118 and a supplementary inlet 119 coupled thereto, respectively, at the other end thereof.

Specifically, the first partition housing 116 has the inlet header 120 coupled at one end thereof in the lengthwise direction and has the supplementary outlet 118 formed at the other end thereof, and includes a first hollow space 114 extended along the lengthwise direction therein such that the first hollow space 114 is communicated with an inlet 122 of the inlet header 120 and the supplementary outlet 118.

Moreover, the second partition housing 117 has the outlet header 130 coupled at one end thereof in the lengthwise direction and has the supplementary inlet 119 formed at the other end thereof, and includes a second hollow space 115 extended along the lengthwise direction therein such that the second hollow space 115 is communicated with an outlet 132 of the outlet header 130 and the supplementary inlet 119.

The first partition housing 116 and the second partition housing 117 are connected with each other such that the hollow spaces 114, 115 formed therein are separated. That is, the first hollow space 114 of the first partition housing 116 and the second hollow space 115 of the second partition housing 117 are separated from each other to form individual spaces, respectively, and wastewater accommodated in the first hollow space 114 of the first partition housing 116 cannot be flowed into the second hollow space 115 of the second partition housing 117.

The wastewater flowed into the first hollow space 114 of the first partition housing 116 through the inlet 122 of the inlet header 120 coupled to the one end of the first partition housing 116 is discharged to an outside of the first partition housing 116 through the supplementary outlet 118 formed at the first partition housing 116, and the wastewater flowed into the first hollow space 115 of the second partition housing 117 through the supplementary inlet 119 formed at the second partition housing 117 is discharged to an outside of the second partition housing 117 through the outlet 132 of the outlet header 130 coupled to the one end of the second partition housing 117.

Here, the hydrogen peroxide supply unit 400 includes the inlet 122 of the inlet header 120 and the supplementary inlet 119 of the second partition housing 117. That is, the wastewater and hydrogen peroxide may be flowed into the first partition housing 116 through the inlet 122 of the inlet header 120, and wastewater and hydrogen peroxide may be flowed into the second partition housing 117 through the supplementary inlet 119 of the second partition housing 117.

Here, the photo oxidation reaction apparatus 1000 illustrated in FIG. 6 and FIG. 7 may further include mixers 510, 520, which mix hydrogen peroxide with the wastewater and discharge the mixed hydrogen peroxide and wastewater to the inlet 122 of the inlet header 120 coupled to the one end of the first partition housing 116 and the supplementary inlet 119 of the second partition housing 117, respectively.

Unlike the photo oxidation reaction apparatus described with reference to FIG. 1 to FIG. 5, the photo oxidation reaction apparatus 1000 illustrated in FIG. 6 and FIG. 7 have the housing of the reactor partitioned, and thus it is possible to reduce a difference in concentration of hydrogen peroxide in the lengthwise direction caused by a structural aspect. In other words, since the length of the hollow space in which the wastewater flows is shorter, it is possible to reduce the difference in concentration of hydrogen peroxide in the lengthwise direction.

The first partition housing 116 and the second partition housing 117 may share the quartz tube 200 and the ultraviolet lamp 300 inserted in the quartz tube 200. That is, the quartz tube 200 may be simultaneously disposed in the first hollow space 114 of the first partition housing 116 and the second hollow space 115 of the second partition housing 117. In such a case, the first partition housing 116 and the second partition housing 117 may be connected with each other in such a way that the hollows spaces 114, 115 are separated from each other but a hole is formed at a portion where the first partition housing 116 and the second partition housing 117 are connected with each other so as to allow the quartz tube 200 to pass through. The hole may be formed to correspond to a diameter of the quartz tube 200.

The photo oxidation reaction apparatus 1000 illustrated in FIG. 6 and FIG. 7 may further include a clamp 600 for coupling the first partition housing 116 and the second partition housing with each other and a sealing member (not shown) interposed between the first partition housing 116 and the second partition housing 117. The sealing member may be arranged to shield the first hollow space 114 of the first partition housing 116 and the second hollow space 115 of the second partition housing 117 from each other.

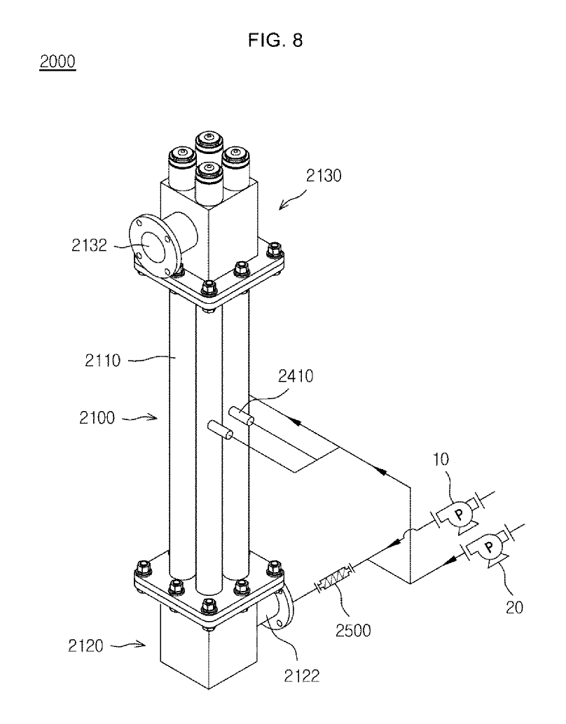

FIG. 8 illustrates a photo oxidation reaction apparatus in accordance with a second embodiment of the present invention.

Referring to FIG. 8, a photo oxidation reaction apparatus 2000 in accordance with a second embodiment of the present invention includes a reactor 2100, a quartz tube (not shown), an ultraviolet lamp (not shown) and a hydrogen peroxide supply unit 2122, 2410, and the reactor 2100 includes a housing 2110, an inlet header 2120 and an outlet header 2130. In describing the photo oxidation reaction apparatus 2000 in accordance with the present embodiment, any description redundant with the photo oxidation reaction apparatus 1000 described with reference to FIG. 1 and FIG. 2 will be omitted.

Although it is illustrated in FIG. 8 as an example that the hydrogen peroxide supply unit includes a plurality of hydrogen peroxide inlets 2122, 2410, this is merely one example, and it is also possible that the hydrogen peroxide supply unit includes the hydrogen peroxide supply tube described above with reference to FIG. 4 and FIG. 5. Hereinafter, the description will be made assuming that the hydrogen peroxide supply unit includes the plurality of hydrogen peroxide inlets 2122, 2410.

The housing 2110 of the photo oxidation reaction apparatus 2000 in accordance with the present embodiment is installed in plurality. The inlet header 2120 is coupled to one ends of the plurality of housings 2110 so as to integrally cover openings formed, respectively, at the one ends of the plurality of housings 2110, and the outlet header 2130 is coupled to the other ends of the plurality of housings 2110 so as to integrally cover openings formed, respectively, at the other ends of the plurality of housings 2110.

Since the photo oxidation reaction apparatus 2000 in accordance with the present embodiment includes the plurality of housings 2110, it is possible to increase the quantity of wastewater to be processed per unit time.

Although it would be possible to increase the quantity of wastewater to be accommodated and processed in the housing by increasing a cross-sectional area and a length of the hollow space formed in the housing, the increased cross-sectional area of the hollow space would limit a range of transmission of ultraviolet rays, thereby possibly deteriorating the efficiency of the apparatus, and the increased length of the hollow space would exacerbate the difference in concentration of hydrogen peroxide in the lengthwise direction of the hollow space, deteriorating the efficiency of the apparatus as well. Therefore, by installing the plurality of housings, it is possible to maintain the efficiency of water treatment by the apparatus and at the same time increase the quantity of wastewater to be processed.

The inlet header 2120 and the outlet header 2130 integrally cover either lengthwise end of the plurality of housings 2110, and coupling surfaces of the inlet header 2120 and the outlet header 2130 being coupled with either end of the plurality of housings 2110 may be each formed with an opening portion corresponding to an opening of each of the plurality of housings 2110, resulting in formation of a plurality of opening portions.

A pipe for inletting wastewater and hydrogen peroxide may be connected to the inlet 2122 of the inlet header 2120 coupled to integrally cover the one end of the plurality of housings 2110, and the wastewater and hydrogen peroxide flowed into a header space of the inlet header 2120 through the inlet 2122 may be flowed into the hollow space of each housing 2110 through the opening of each housing 2110.

Although it is illustrated in FIG. 8 that the reactor 2100 includes 4 housings 2110, the number of housings 2110 may be properly added or deducted according to, for example, the quantity of wastewater to be processes per unit time and the output of the ultraviolet lamp. Moreover, the plurality of housings 2110 may be arranged in various ways, for example, by arranging in an array or arranging alternately, and may be preferably arranged to minimize the sizes of the inlet header 2120 and the outlet header 2130 that integrally cover the plurality of housings 2110.

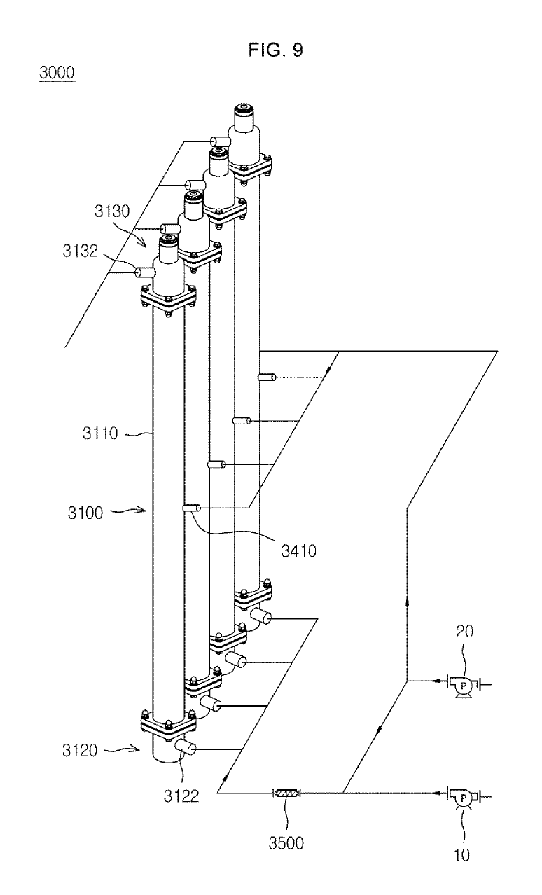

FIG. 9 illustrates a photo oxidation reaction apparatus in accordance with a third embodiment of the present invention.

Referring to FIG. 9, a photo oxidation reaction apparatus 3000 in accordance with the present embodiment has a plurality of reactors 3100 installed therein, and the plurality of reactors 3100 are each installed with an inlet 3122, through which wastewater is flowed in. Hereinafter, any description redundant with the photo oxidation reaction apparatus 1000 described with reference to FIG. 1 and FIG. 2 will be omitted.

Since the reactors 3100 of the photo oxidation reaction apparatus 3000 in accordance with the present embodiment is installed in plurality, it is possible to increase the quantity of wastewater to be processed per unit time, similarly to the photo oxidation reaction apparatus 2000 in accordance with the second embodiment of the present invention illustrated in FIG. 2.

The only difference is that while the photo oxidation reaction apparatus 2000 in accordance with the second embodiment of the present invention has the housings 2110 installed in plurality, the photo oxidation reaction apparatus 3000 in accordance with the third embodiment of the present invention has the reactors 3100 installed in plurality.

As illustrated in FIG. 9, by installing the plurality of reactors 3100 and arranging each of the plurality of reactors 3100 to allow wastewater to be flowed in through the inlet 3122 of its own, it is possible not only to multiply the quantity of wastewater to be processed per unit time but also to selectively operate the reactors 3100. In other words, by operating some of the plurality of reactors 3100, the quantity of wastewater to be processed may be controlled.

Here, the inlets 3122 of the plurality of reactors 3100 may be connected with a plurality of pipes, respectively, for inletting the wastewater and supplying hydrogen peroxide, and the plurality of pipes may be may be branched from a pipe connected to a wastewater inlet pump 10.

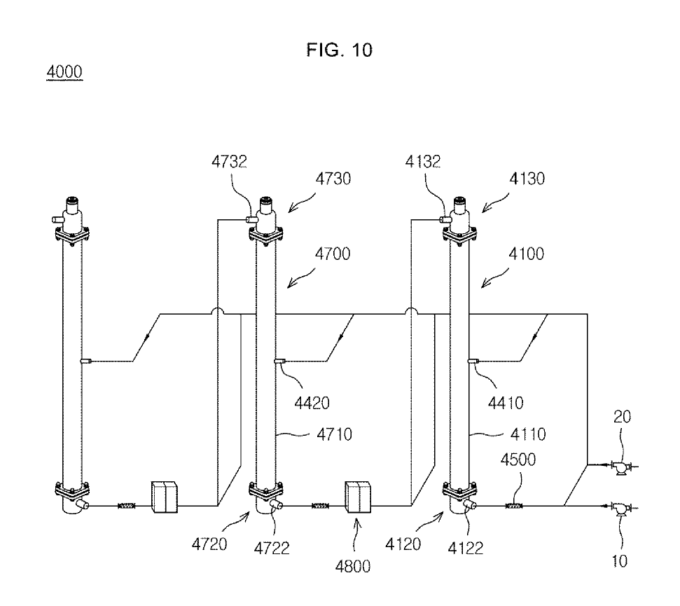

FIG. 10 illustrates a photo oxidation reaction apparatus in accordance with a fourth embodiment of the present invention.

Referring to FIG. 10, a photo oxidation reaction apparatus 4000 in accordance with the present embodiment is further installed with an additional reactor 4700 for re-treatment of wastewater flowed out from an outlet 4132 of a reactor 4100, and the additional reactor 4700 is arranged in such a way that the wastewater flowed out from the outlet 4132 of the reactor 4100 is flowed into the additional reactor 4700 through an inlet 4722 of the additional reactor 4700.

Meanwhile, since the reactor 4100 and the additional reactor 4700 included in the photo oxidation reaction apparatus 4000 in accordance with the present embodiment include substantially identical elements to those of the reactor described above with reference to FIG. 1 to FIG. 3, these elements will not be described herein redundantly.

After primary water treatment by passing through the reactor 4100, the wastewater may be processed for secondary water treatment by passing through the additional reactor 4700. Accordingly, by undertaking multiple processes of water treatment, it is possible to improve the performance of water treatment of the apparatus.

The water treatment process may be performed 3 or more times, when necessary. Although FIG. 10 illustrates the photo oxidation reaction apparatus 4000 performing 3 processes of water treatment, the number of water treatment processes and the number of reactors arranged therein may be added or deducted according to the required extent of treatment of wastewater.

A connector pipe for inletting and outletting the wastewater may be installed between the outlet 4132 of the reactor 4100, which performs the primary water treatment, and the inlet 4722 of the additional reactor 4700, which performs the secondary water treatment.

Moreover, pipes for supplying hydrogen peroxide may be connected to hydrogen peroxide inlets 4410, 4122 installed on the reactor 4100 and hydrogen peroxide inlets 4420, 4722 installed on the additional reactor 4700.

Moreover, the photo oxidation reaction apparatus 4000 in accordance with the present embodiment may further include a temperature controller and pH controller 4800 installed between the outlet 4132 of the reactor 4100 and the inlet 4722 of the additional reactor 4700 such that the wastewater is supplied to the inlet 4722 of the additional reactor 4700, in which the secondary water treatment is carried out, by adjusting the temperature and pH of the wastewater discharged from the outlet 4132 of the reactor 4100, in which the primary water treatment is performed.

In order to enhance the efficiency of a water treatment reaction inside the reactor 4100 and the additional reactor 4700, the temperature controller 4800 may be installed to adjust the temperature of the wastewater that is changed by a heat generated by an ultraviolet lamp, and the pH controller 4800 is installed to adjust the acidity of the wastewater that is changed by intermediate products generated during oxidation and decomposition of contaminants contained in the wastewater.

For example, the temperature of the wastewater may be controlled to be between 4° C. and 40° C., and the acidity of the wastewater may be controlled to be between pH 6 and pH 10.

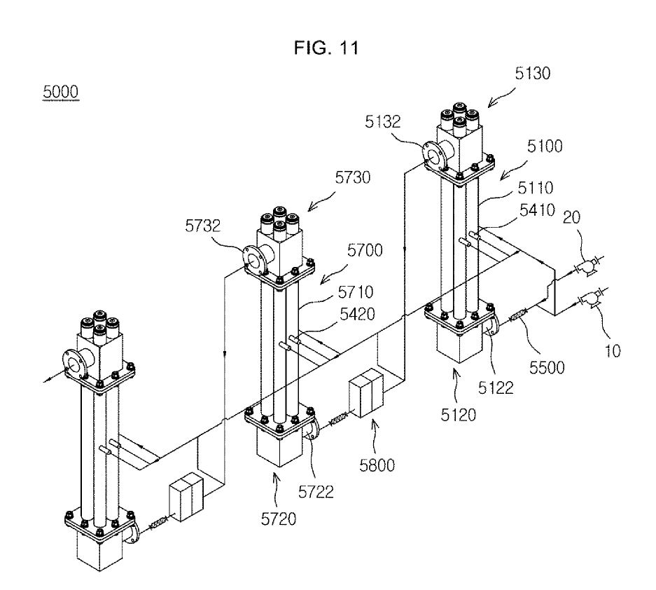

FIG. 11 illustrates a photo oxidation reaction apparatus in accordance with a fifth embodiment of the present invention.

Referring to FIG. 11, a photo oxidation reaction apparatus 5000 in accordance with the present embodiment is combined with the photo oxidation reaction apparatus 2000 shown in FIG. 8 and the photo oxidation reaction apparatus 4000 shown in FIG. 10, and includes a reactor 5100, which includes a plurality of housings 5110, and an additional reactor 5700, which includes a plurality of housings 5710.

The photo oxidation reaction apparatus 5000 in accordance with the present embodiment can increase the quantity of wastewater to be treated per unit time because the reactor 5100 includes the plurality of housings 5110 and can improve the performance of water treatment of the apparatus because the additional reactor 5700 includes the plurality of housings 5710.

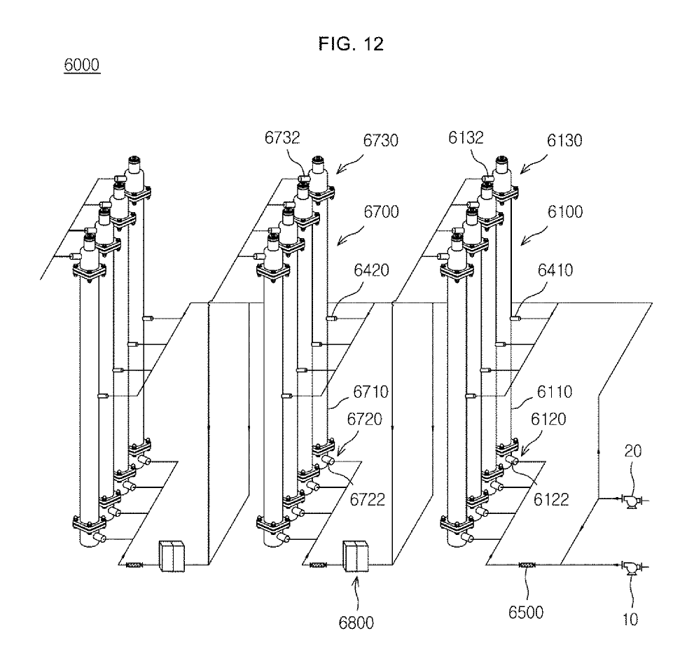

FIG. 12 illustrates a photo oxidation reaction apparatus in accordance with a sixth embodiment of the present invention.

Referring to FIG. 12, a photo oxidation reaction apparatus 6000 in accordance with the present embodiment is combined with the photo oxidation reaction apparatus 3000 shown in FIG. 9 and the photo oxidation reaction apparatus 4000 shown in FIG. 10, and includes a plurality of reactors 6100, in which primary water treatment is performed, and a plurality of additional reactors 6700, in which secondary water treatment is performed.

Since the photo oxidation reaction apparatus 6000 in accordance with the present embodiment includes the plurality of reactors 6100 in which primary water treatment is performed, it is possible to improve the efficiency of operating the apparatus because the quantity of wastewater to be treated per unit time can be increased and some of the plurality of reactors 6100 can be selectively operated.

Moreover, since the photo oxidation reaction apparatus 6000 in accordance with the present embodiment includes the plurality of additional reactors 6700 in which secondary water treatment is performed, it is possible to improve the performance of water treatment.

Although certain embodiments of the present invention have been described above, it shall be appreciated that there can be a variety of permutations and modifications of the present invention by those who are ordinarily skilled in the art to which the present invention pertains without departing from the technical ideas and scope of the present invention, which shall be defined by the appended claims. It shall be also appreciated that a large number of other embodiments than the above-described embodiments are included in the claims of the present invention.

What is claimed is:

1. An apparatus for photo oxidation reaction, comprising:
a reactor comprising: a housing having a hollow space extended therein in a lengthwise direction and having openings formed at either end thereof in the lengthwise direction so as to open the hollow space to an outside; an inlet header having an inlet formed thereon for communication with the hollow space in order to allow wastewater to be flowed into the hollow space and being coupled to one end of the housing so as to cover the opening formed at the one end of the housing; and an outlet header having an outlet formed thereon for communication with the hollow space in order to allow the wastewater having passed through the hollow space to be flowed out to an outside and being coupled to the other end of the housing so as to cover the opening formed at the other end of the housing;
a quartz tube formed to be extended along the lengthwise direction of the housing and installed in the reactor so as to be arranged inside the housing;
an ultraviolet lamp inserted in the quartz tube so as to emit ultraviolet rays to the hollow space; and
a hydrogen peroxide supply unit installed on the so as to disperse and supply hydrogen peroxide to the hollow space at a plurality of locations separated in the lengthwise direction of the housing.

2. The apparatus of claim 1, wherein the housing is installed in plurality,
wherein the inlet header is coupled to one ends of the plurality of housings so as to integrally cover openings formed, respectively, at the one ends of the plurality of housings, and
wherein the outlet header is coupled to the other ends of the plurality of housings so as to integrally cover openings formed, respectively, at the other ends of the plurality of housings.

3. The apparatus of claim 1, wherein the hydrogen peroxide supply unit comprises a plurality of hydrogen peroxide inlets communicated with the hollow space and separated from one another in the lengthwise direction of the housing.

4. The apparatus of claim 3, wherein the hydrogen peroxide supply unit comprises the inlet formed on the inlet header.

5. The apparatus of claim 1, wherein the hydrogen peroxide supply unit comprises a hydrogen peroxide supply tube installed in the hollow space and having a plurality of through-holes formed therein such that hydrogen peroxide flowed into the reactor through one open end of the hydrogen peroxide supply unit that is arranged to be exposed to the outside of the reactor is dispersed and supplied to the hollow space.

6. The apparatus of claim 5, wherein the hydrogen peroxide supply tube is formed in a spiral shape arranged to surround an outer circumferential surface of the quartz tube.

7. The apparatus of claim 5, wherein the hydrogen peroxide supply tube is formed in an annular shape arranged to surround an outer circumferential surface of the quartz tube at least once.

8. The apparatus of claim 1, wherein the housing is divided into a first partition housing and a second partition housing having the inlet header and the outlet header coupled thereto, respectively, at one end thereof in the lengthwise direction of the housing,
wherein the first partition housing comprises a supplementary outlet formed at the other end thereof so as to be communicated with a hollow space formed therein,
wherein the second partition housing comprises a supplementary inlet formed at the other end thereof so as to be communicated with a hollow space formed therein,
wherein the first partition housing and the second partition housing are connected with each other such that the respective hollow spaces are separated from each other, and
wherein the hydrogen peroxide supply unit comprises the inlet of the inlet header and the supplementary inlet of the second partition housing.

9. The apparatus of claim 1, wherein the reactor is installed in plurality, and
wherein the plurality of reactors are arranged such that wastewater is flowed in through an inlet of each of the plurality of reactors.

10. The apparatus of claim 1, further comprising an additional reactor installed to re-treat the wastewater flowed out from the outlet of the reactor, and
wherein the additional reactor is arranged in such a way that the wastewater flowed out from the outlet of the reactor is flowed into the additional reactor through an inlet of the additional reactor.

11. The apparatus of claim 10, wherein the reactor and/or the additional reactor are installed in plurality.

12. The apparatus of claim 10, further comprising a temperature controller and pH controller installed between the outlet of the reactor and the inlet of the additional reactor such that the wastewater is supplied to the inlet of the additional reactor by adjusting the temperature and pH of the wastewater discharged from the outlet of the reactor.

13. The apparatus of claim 2, wherein the hydrogen peroxide supply unit comprises a plurality of hydrogen peroxide inlets communicated with the hollow space and separated from one another in the lengthwise direction of the housing.

14. The apparatus of claim 2, wherein the hydrogen peroxide supply unit comprises a hydrogen peroxide supply tube installed in the hollow space and having a plurality of through-holes formed therein such that hydrogen peroxide flowed into the reactor through one open end of the hydrogen peroxide supply unit that is arranged to be exposed to the outside of the reactor is dispersed and supplied to the hollow space.

15. The apparatus of claim 2, wherein the housing is divided into a first partition housing and a second partition housing having the inlet header and the outlet header coupled thereto, respectively, at one end thereof in the lengthwise direction of the housing,
wherein the first partition housing comprises a supplementary outlet formed at the other end thereof so as to be communicated with a hollow space formed therein,
wherein the second partition housing comprises a supplementary inlet formed at the other end thereof so as to be communicated with a hollow space formed therein,
wherein the first partition housing and the second partition housing are connected with each other such that the respective hollow spaces are separated from each other, and
wherein the hydrogen peroxide supply unit comprises the inlet of the inlet header and the supplementary inlet of the second partition housing.

16. The apparatus of claim 2, wherein the reactor is installed in plurality, and
wherein the plurality of reactors are arranged such that wastewater is flowed in through an inlet of each of the plurality of reactors.

17. The apparatus of claim 2, further comprising an additional reactor installed to re-treat the wastewater flowed out from the outlet of the reactor, and
wherein the additional reactor is arranged in such a way that the wastewater flowed out from the outlet of the reactor is flowed into the additional reactor through an inlet of the additional reactor.

18. The apparatus of claim 14, wherein the hydrogen peroxide supply tube is formed in a spiral shape arranged to surround an outer circumferential surface of the quartz tube.

19. The apparatus of claim 14, wherein the hydrogen peroxide supply tube is formed in an annular shape arranged to surround an outer circumferential surface of the quartz tube at least once.
